(19) United States
(12) Patent Application Publication
(10) Pub. No.: US 2026/0231977 A1
(43) Pub. Date: Aug. 13, 2026

(54) ICE MIX AND FROZEN DESSERT

(71) Applicant: LOTTE CO., LTD., Tokyo (JP)

(72) Inventors: Yoko ICHIMASA, Saitama (JP); Yosuke SUZUKI, Saitama (JP); Yoshihiro YOKOTA, Saitama (JP)

(73) Assignee: LOTTE CO., LTD., Tokyo (JP)

(21) Appl. No.: 19/156,696

(22) PCT Filed: Feb. 19, 2024
(86) PCT No.: PCT/JP2024/005681

§ 371 Date: Aug. 15, 2025

(30) Foreign Application Priority Data
Mar. 10, 2023 (JP) 2023-037442

(51) Int. Cl. A23G 9/42; A23G 9/32; A23G 9/38; A23J 3/16

(52) U.S. Cl. CPC A23G 9/42; A23G 9/325; A23G 9/38; A23J 3/16

(57) ABSTRACT

An ice mix including:
a plant-derived protein; and
sodium citrate; wherein
an amount of solids contained in the ice mix is 40 to 50 mass % based on a mass of the ice mix, and
the ice mix satisfies a relationship of expression (1):

$$Y \geq 0. 0 \; 45 X - 1.75 ( 40 \leq X \leq 50 ) \qquad ( 1 )$$

wherein
Y denotes mass % of the sodium citrate based on the mass of the ice mix, and
X denotes mass % of the solids based on the mass of the ice mix.

### TECHNICAL FIELD

The present invention relates to an ice mix and a frozen dessert.

### BACKGROUND ART

In recent years, the market for plant-based frozen desserts has been expanding in the overseas market for frozen desserts, and the demand for frozen desserts using plant materials has been increasing also in Japan from the viewpoint of SDGs. Among consumers, environmentally conscious people are replacing general frozen desserts using dairy products with plant-based frozen desserts.

Regarding a plant-based frozen dessert, for example, Patent Literature 1 discloses “concentrated soy milk containing 2.5 wt % or more of carbohydrate in which a weight ratio of the carbohydrate to a protein is set to 0.4 or more” and a frozen dessert containing the concentrated soy milk for the purpose of providing concentrated soy milk, which has a well-balanced rich flavor peculiar to soy milk and original umami and richness of soy milk, and a frozen dessert containing the concentrated soy milk.

### CITATION LIST

### Patent Literature

Patent Literature 1: JP 2006-136298 A

### SUMMARY OF INVENTION

### Technical Problem

In a frozen dessert with a relatively large solid content using a plant material, protein aggregation and an increase in viscosity of an ice mix occur, which may make production difficult. Operationally, freezing is not always performed immediately after mixing an ice mix raw material, and particularly, an increase in viscosity of the ice mix is observed when one or two days have elapsed as it is. In addition, roughness is sensed due to aggregation of proteins, and the quality may deteriorate.

Therefore, the present invention is directed to providing an ice mix with suppressed viscosity increase and reduced roughness.

### Solution to Problem

The present inventors have extensively conducted studies and resultantly found that use of a predetermined amount of sodium citrate make it possible to suppress an increase in viscosity and reduce roughness.

Patent Literature 1 does not disclose that use of a predetermined amount of sodium citrate can suppress an increase in viscosity and reduce roughness.

The present invention includes the following embodiments.

[1]

An ice mix including:
a plant-derived protein; and
sodium citrate, wherein
an amount of solids contained in the ice mix is 40 to 50 mass % based on a mass of the ice mix, and
the ice mix satisfies a relationship of expression (1):

$$Y \geq 0. 0 \; 45 X - 1.75 ( 40 \leq X \leq 50 ) \qquad ( 1 )$$

wherein
Y denotes mass % of the sodium citrate based on the mass of the ice mix, and
X denotes mass % of the solids based on the mass of the ice mix.
   [2]

The ice mix according to [1], which satisfies a relationship of expression (2):

$$Y \geq 0.04 X - 1.5 ( 40 \leq X \leq 50 ) \qquad ( 2 )$$

wherein Y and X are as described in [1].
   [3]

The ice mix according to [1] or [2], wherein the plant-derived protein is derived from at least one selected from the group consisting of pea, soybean, and oat.

[4]

The ice mix according to any one of [1] to [3], including no dairy product.

[5]

A frozen dessert including the ice mix according to any one of [1] to [4].

### Advantageous Effects of Invention

According to the present invention, it is possible to provide an ice mix with suppressed viscosity increase and reduced roughness.

### DESCRIPTION OF EMBODIMENTS

Hereinafter, embodiments of the present invention will be specifically described, but the present invention is not limited to these embodiments, and can be modified in various ways without departing from the gist thereof.

### <Ice Mix>

An embodiment of the present invention relates to an ice mix including a plant-derived protein and sodium citrate, wherein
an amount of solids contained in the ice mix is 40 to 50 mass % based on a mass of the ice mix, and
the ice mix satisfies a relationship of expression (1):

$$Y \geq 0. 0 \; 45 X - 1.75 ( 40 \leq X \leq 50 ) \qquad ( 1 )$$

wherein
Y denotes mass % of the sodium citrate based on the mass of the ice mix, and
X denotes mass % of the solids based on the mass of the ice mix.

The ice mix according to the present embodiment can suppress an increase in viscosity and reduce roughness by containing a predetermined amount of sodium citrate.

The ice mix according to this embodiment contains 40 to 50 mass % of solids based on the mass of the ice mix. An ice mix containing such a large amount of solids tends to cause an increase in viscosity and protein aggregation, and thus is a suitable object of the present invention. The term “solids” used herein refers to a component remaining after removing water from the ice mix.

The ice mix according to this embodiment contains a plant-derived protein. The type of the plant-derived protein is not particularly limited, and examples thereof include a protein derived from at least one selected from the group consisting of pea, soybean, and oat.

The protein derived from peas (hereinafter, referred to as “pea protein”) is preferably a powdered protein separated and extracted from peas using only water. The peas are preferably yellow peas (scientific name: Pisum sativum).

The protein derived from soybeans (hereinafter, referred to as “soybean protein”) is preferably a protein contained in a soy milk cream and/or a low-fat soy milk. The soy milk cream is a component separated from soybean and preferably has a protein content of 3 to 8 mass % (preferably 5 to 6 mass %) and a lipid content of 10 to 15 mass % (preferably 12 to 13 mass %), and more preferably has a soy milk cream fraction obtained according to the Ultra Soy Separation (USS) manufacturing method developed by Fuji Oil Co., Ltd. The low-fat soy milk is a component separated from soybean and preferably has a protein content of 3 to 8 mass % (preferably 5 to 6 mass %) and a lipid content of 0 to 3 mass % (preferably 0 to 1 mass %), and more preferably has a low-fat soy milk fraction obtained according to the USS manufacturing method.

The use of the pea protein in combination with the soy milk cream and/or the low-fat soy milk, preferably use of the pea protein in combination with the soy milk cream and the low-fat soy milk, makes it possible to suppress the odor and taste peculiar to beans and improve the body feeling and richness of frozen desserts.

The protein derived from oat (hereinafter, referred to as “oat protein”) is preferably a protein contained in powder obtained by saccharifying powdered oat and spray-drying the saccharified solution. Saccharification produces sweetness, making it suitable for use in a frozen dessert.

The amount (total amount) of the plant-derived protein is preferably 0.5 to 7 mass %, more preferably 1 to 6 mass %, and still more preferably 1.5 to 5.5 mass %, based on the mass of the ice mix, from the viewpoint of stabilizing the taste and bubbles as a whole, smoothing the tissue, and forming a body.

The ice mix according to this embodiment contains a predetermined amount of sodium citrate. The use of sodium citrate makes it possible to suppress an increase in viscosity and reduce roughness.

Sodium citrate is preferably used in an amount satisfying the relationship of the following expression (1):

$$Y \geq 0. 0 \; 45 X - 1.75 ( 40 \leq X \leq 50 ) \qquad ( 1 )$$

wherein
Y denotes mass % of the sodium citrate based on the mass of the ice mix, and
X denotes mass % of the solids based on the mass of the ice mix.

Sodium citrate is more preferably used in an amount satisfying the relationship of the following expression (2):

$$Y \geq 0.04 X - 1.5 ( 40 \leq X \leq 50 ) \qquad ( 2 )$$

wherein Y and X are as described above.

Expressions (1) and (2) indicate that as the amount of solids in the ice mix increases, the required amount of sodium citrate also increases, which are defined from specific experimental results.

The amount of sodium citrate may be determined based on the mass of the ice mix. Specifically, the amount of sodium citrate is preferably 0.05 to 3.0 mass %, and more preferably 0.1 to 3.0 mass %, based on the mass of the ice mix.

The ice mix according to this embodiment may contain additional components. Examples of the additional component include fats and oils (for example, plant-based fats and oils), sugars (including sugar alcohols), salts, emulsifiers, stabilizers, fragrances, coloring agents, fruit juices, dairy products, acidulants, pH adjusters, and water.

The amount of fat and oil is not particularly limited, but is preferably 0 to 20% by mass, more preferably 1 to 18% by mass, and still more preferably 5 to 15% by mass, based on the mass of the ice mix.

The amount of sugar (including sugar alcohol) is not particularly limited, but is preferably 1 to 50 mass %, more preferably 10 to 45 mass %, and still more preferably 15 to 43 mass %, based on the mass of the ice mix.

The ice mix according to this embodiment preferably contains no dairy product, more preferably no animal raw material. A frozen dessert produced from an ice mix containing no dairy product is classified as the ice sweet described later. The term “dairy product” used herein is a product derived from animal milk, and examples thereof include a product derived from cow milk.

### <Frozen Dessert>

An embodiment of the present invention relates to a frozen dessert including the ice mix described above.

The term “frozen dessert” used herein refers to a dessert stored under freezing conditions, such as ice creams and ice sweets, and does not include a dessert stored in a chilled temperature zone, such as pudding.

The ice creams encompass ice cream, ice milk, and lacto-ice. The terms “ice creams”, “ice cream”, “ice milk”, and “lacto-ice” used herein are in accordance with the provisions of “Ministerial Ordinance Concerning Compositional Standards, etc., for Milk and Milk Products” (MHLW Ordinance No. 106 dated Aug. 8, 2018).

Specifically, the ice creams are products obtained by freezing after processing milk or food produced from milk as a raw material, or after setting milk or food produced from milk as a main raw material, and each of the products contains 3.0% or more of milk solids (except for fermented milk).

The ice cream is a product containing 15.0% or more of milk solids and 8.0% or more of milk fat.

The ice milk is a product containing 10.0% or more of milk solids and 3.0% or more of milk fat (except for the ice cream).

The lacto ice is a product containing 3.0% or more of milk solids (except for the ice cream and the ice milk).

The ice sweet is a product containing less than 3.0% of milk solids.

The frozen dessert according to this embodiment may contain an ice flake. The term “ice flake” used herein refers to a piece that is added separately from the ice mix and has a length of 0.06 mm or more. Ice flakes are distinguished from ice crystals (typically 30 to 55 μm) formed by freezing water in the ice mix.

The average length of the ice flakes is preferably 0.06 to 14 mm, more preferably 0.06 to 1.7 mm, and still more preferably 0.06 to 1.0 mm. The average length of the ice flakes may be, for example, 0.10 to 1.7 mm, 0.15 to 1.7 mm, 0.10 to 1.0 mm, or 0.15 to 1.0 mm. When the average length of the ice flake falls within the above ranges, it is possible to give a smooth texture and cool feeling.

The term “length” of the ice flake used herein means a distance between two points at which a distance between any two points on the outer edge of the ice flake photographed using an optical microscope or observed with the naked eye is maximum. The term “average length” of ice flakes used herein refers to an average value of lengths of randomly selected 100 ice flakes.

The amount of ice flakes can be, for example, 10 to 80 mass %, 20 to 70 mass %, or 30 to 60 mass %, based on the mass of the frozen dessert.

### EXAMPLES

Hereinafter, the present invention will be described in more detail with reference to Examples and Comparative Examples, but the technical scope of the present invention is not limited thereto.

### <Production of Ice Mix>

Components shown in Table 1 below were mixed to produce an ice mix.

TABLE 1

| | Formulation 1 | Formulation 2 | Formulation 3 | Formulation 4 |
|---|---|---|---|---|
| | Solids content: | Solids content: | Solids content: | Solids content: |
| | 50 mass % | 40 mass % | 30 mass % | 40 mass % |
| Soy milk cream | 5.0 | 5.0 | 5.0 | — |
| Low-fat soy milk | 10.0 | 10.0 | 10.0 | — |
| Pea protein | 1.5 | 1.5 | 1.5 | — |
| Oat milk powder | — | — | — | 25.0 |
| Plant-based fat and oil | 10.0 | 10.0 | 10.0 | 10.0 |
| Sugar | 42.7 | 29.7 | 16.5 | 30.2 |
| Refined salt | 0.3 | 0.3 | 0.3 | 0.3 |
| Stabilizer | 0.1 | 0.1 | 0.1 | 0.1 |
| Emulsifier | 0.2 | 0.2 | 0.2 | 0.2 |
| Blending water | 30.3 | 43.3 | 56.5 | 34.3 |
| Total | 100.0 | 100.0 | 100.0 | 100.0 |

### <Evaluation of Ice Mix>

A predetermined amount of sodium citrate was added (or not added) to each ice mix to perform various evaluations. Various evaluation methods are as follows, and the evaluation results are shown in Table 2. In the reference example in which the ice mix had a solids content of 30 mass %, it was not necessary to add sodium citrate since no viscosity increase or roughness occurred.

### [Viscosity]

The viscosity was measured by the following method, and when the viscosity was 1000 cP or more, it was determined that the production was not proper.

### (Measurement Method)

1. A measurement liquid, ice mix, was prepared in a 200 ml (inner diameter: 67 mm) beaker.

2. The temperature of the measurement liquid was adjusted to 10° C.

3. A guard rotor was attached to a viscometer.

4. The inside of the temperature-controlled beaker was stirred 20 times, and then the viscosity was measured.

### (Measurement Conditions)

Apparatus: TVB-10 viscometer (manufactured by Toki Sangyo Co., Ltd.)
Rotor: No. 21 (M2) or No. 22 (M3)
Rotation speed: 30 rpm
Time: 30 seconds

### [Homogenizer Processing]

The purpose of homogenization with a homogenizer was to atomize fat globules in an ice mix to form an emulsified state, and also to uniformly disperse components other than fat. Homogeneous pressure varies depending on the components of the ice mix and the structure of a homogeneous valve, but is usually 100 to 150 kg/cm² (total of the first stage and the second stage). This time, about 2 kg of ice mix at about 70° C. after sterilization was treated at a pressure of 80 kg/cm² in the first stage and 35 kg/cm² in the second stage using a two-stage homogenizer.

The feasibility of homogenizer processing was determined based on whether or not the ice mix came out from an outlet of the homogenizer. When the roughness was large, the homogenizer machine got clogged, and the ice mix did not come out. When the homogenizer processing was not possible, it was determined that the production was not proper.

### [Sensory Evaluation]

Sensory evaluation of the ice mix for roughness and powderiness was performed by five trained expert panelists. The evaluation criteria are as follows.

### (Evaluation Criteria)

1: A large, firm roughness like sand was sensed.

2: A firm roughness was sensed.

3: Fine but slight roughness was sensed.

4: Not much roughness, but occasionally fine roughness was sensed.

5: No roughness was sensed at all. Smooth mix state.

### [Particle Size (Median Diameter D50)]

The particle size (median diameter D50) was measured under the following conditions. When the median diameter exceeds 11.5 μm, roughness tends to be sensed.

### (Measurement Conditions)

Apparatus: Microtrac particle size distribution measuring apparatus (MT3300EX)
Particle refractive index: 1.81
Solvent: water
Solvent refractive index: 1.333

TABLE 2

| | Comparative | Comparative | Comparative | | Comparative | Example | |
|---|---|---|---|---|---|---|---|
| | Example 1A | Example 1B | Example 1C | Example 1 | Example 2 | 2A | Example2B |
| Ice mix | Formulation 1 | | | | Formulation 2 | | |
| (Solids content: mass %) | (50) | | | | (40) | | |
| Sodium citrate (mass %) | 0.00 | 0.05 | 0.2 | 0.5 | 0.00 | 0.05 | 0.1 |
| Expression (1) | x | x | x | ∘ | x | ∘ | ∘ |
| Expression (2) | x | x | x | ∘ | x | x | ∘ |
| Protein-deriving plant | Pea | | | | | | |
| | soybean | | | | | | |
| Protein content | 2.0 | 2.0 | 2.0 | 2.0 | 2.0 | 2.0 | 2.0 |
| (total mass %) | | | | | | | |
| Viscosity (cP): | 98 | 101 | 415 | 535 | 642 | 426 | 478 |
| same day | | | | | | | |
| Viscosity (cP): | 99 | 96 | 677 | 514 | 1000≥ | 801 | 622 |
| 24 Hr (1 cycle) | | | | | | | |
| Viscosity (cP): | 101 | 97 | 1000≥ | 679 | 1000≥ | 1000≥ | 625 |
| 48 Hr (2 cycles) | | | | | | | |
| Homogenizer processing | Impossible | Impossible | Possible | Possible | Possible | Possible | Possible |
| Sensory evaluation: | | | | | | | |
| roughness, powderiness | | | | | | | |
| Panelist 1 | 1 | 1 | 2 | 4 | 2 | 4 | 5 |
| Panelist 2 | 1 | 2 | 1 | 4 | 2 | 3 | 5 |
| Panelist 3 | 2 | 2 | 2 | 4 | 1 | 4 | 5 |
| Panelist 4 | 1 | 1 | 2 | 4 | 1 | 4 | 5 |
| Panelist 5 | 2 | 1 | 2 | 4 | 2 | 4 | 5 |
| Panelist average | 1.4 | 1.4 | 1.8 | 4 | 1.6 | 3.8 | 5 |
| Particle size | — | — | 11.780 | 7.468 | 15.060 | 11.410 | 7.016 |
| (median diameter D50) | | | | | | | |
| (μm) | | | | | | | |

| | Example | Example | Comparative | | Reference |
|---|---|---|---|---|---|
| | 2C | 2D | Example 3 | Example 3 | Example |
| Ice mix | Formulation 2 | | Formulation 4 | | Formulation 3 |
| (Solids content: mass %) | (40) | | (40) | | (30) |
| Sodium citrate (mass %) | 3.0 | 0.1 | 0.0 | 0.5 | 0.0 |
| Expression (1) | ∘ | ∘ | x | ∘ | — |
| Expression (2) | ∘ | ∘ | x | ∘ | — |
| Protein-deriving plant | Pea | | Oat | | Pea |
| | soybean | | | | soybean |
| Protein content | 2.0 | 5.0 | 2.0 | 2.0 | 2.0 |
| (total mass %) | | | | | |
| Viscosity (cP): | 275 | 458 | 121 | 42 | 487 |
| same day | | | | | |
| Viscosity (cP): | 205 | 544 | 157 | 58 | 815 |
| 24 Hr (1 cycle) | | | | | |
| Viscosity (cP): | 231 | 526 | 153 | 60 | 868 |
| 48 Hr (2 cycles) | | | | | |
| Homogenizer processing | Possible | Possible | Possible | Possible | Possible |
| Sensory evaluation: | | | | | |
| roughness, powderiness | | | | | |
| Panelist 1 | 5 | 5 | 2 | 5 | 5 |
| Panelist 2 | 5 | 4 | 2 | 4 | 5 |
| Panelist 3 | 5 | 5 | 2 | 5 | 5 |
| Panelist 4 | 5 | 5 | 3 | 5 | 5 |
| Panelist 5 | 5 | 5 | 3 | 5 | 5 |
| Panelist average | 5 | 4.8 | 2.4 | 4.8 | 5 |
| Particle size | 5.093 | 5.066 | 11.570 | 6.560 | 10.230 |
| (median diameter D50) | | | | | |
| (μm) | | | | | |

1. An ice mix comprising:
a plant-derived protein; and
sodium citrate, wherein
an amount of solids contained in the ice mix is 40 to 50 mass % based on a mass of the ice mix, and
the ice mix satisfies a relationship of expression (1):
$$Y \geq 0. 0 \; 45 X - 1.75 ( 40 \leq X \leq 50 ) \qquad ( 1 )$$
wherein
Y denotes mass % of the sodium citrate based on the mass of the ice mix, and
X denotes mass % of the solids based on the mass of the ice mix.

2. The ice mix according to claim 1, which satisfies a relationship of expression (2):
$$Y \geq 0.04 X - 1.5 ( 40 \leq X \leq 50 ) \qquad ( 2 )$$
wherein Y and X are as described in claim 1.

3. The ice mix according to claim 1, wherein the plant-derived protein is derived from at least one selected from the group consisting of pea, soybean, and oat.

4. The ice mix according to claim 1, comprising no dairy product.

5. A frozen dessert comprising the ice mix according to claim 1.

6. The ice mix according to claim 2, wherein the plant-derived protein is derived from at least one selected from the group consisting of pea, soybean, and oat.

7. The ice mix according to claim 2, comprising no dairy product.

8. A frozen dessert comprising the ice mix according to claim 2.
